(19) United States
(12) Patent Application Publication
(10) Pub. No.: US 2015/0330487 A1
(43) Pub. Date: Nov. 19, 2015

(54) BALL SCREW DRIVE, IN PARTICULAR FOR A LOCKING BRAKE OF A MOTOR VEHICLE

(71) Applicant: SCHAEFFLER TECHNOLOGIES AG & CO. KG, Herzogenaurach (DE)

(72) Inventors: Sigurd Wilhelm, Herzogenaurach (DE); Dieter Adler, Herzogenaurach (DE); Nicky Heinrich, Neustadt a.d. Aisch (DE); Stefanie Oeder, Baudenbach (DE); Bernhard Wiesneth, Erlangen (DE)

(73) Assignee: Schaeffler Technologies AG & Co. KG, Herzogenaurach (DE)

(21) Appl. No.: 14/443,184

(22) PCT Filed: Nov. 11, 2013
(86) PCT No.: PCT/DE2013/200293

§ 371 Date: May 15, 2015

(30) Foreign Application Priority Data
Nov. 30, 2012 (DE) 10 2012 221 984.6
Jan. 30, 2013 (DE) 10 2013 201 498.8
Feb. 8, 2013 (DE) 10 2013 202 099.6

(51) Int. Cl. F16H 25/22; F16D 65/18

(52) U.S. Cl. CPC F16H 25/2233; F16D 65/18; F16D 2125/40

(57) ABSTRACT

A ball screw drive (1), including a spindle nut (8) disposed on a threaded spindle (7) and having a helical ball channel (12) which is delimited by ball grooves (10, 11) of the threaded spindle (7) and of the spindle nut (8) and in which a ball row (14) formed of balls (13) is disposed. The ball screw drive further includes a helical spring (10) which is disposed along the helical ball channel (12), is supported relative to the spindle nut (8), and is provided for contact on the ball row (14) or on a ball cage (14) which receives the balls (13). A rod (17, 21) is provided for stabilizing the helical spring (15) that engages in the helical spring (15).

### BACKGROUND

The present invention relates to a ball screw drive. Ball screw drives convert a relative rotation between a threaded spindle and a spindle nut into a translational relative displacement between the threaded spindle and the spindle nut. The invention also relates to locking brakes of motor vehicles that are provided with such ball screw drives. In this application, for example, the spindle nut can be displaced in the axial direction through rotation of the spindle nut and can be pressed against a brake piston that can in turn press a brake pad against a brake disk.

From DE102009051123 A1, for example, a ball screw drive became known for a motor vehicle brake that can be actuated electromechanically. FIG. 4 of that publication shows a ball screw drive with a spindle nut arranged on a threaded spindle. With their ball grooves, the spindle nut and the threaded spindle define a helical ball channel that is wound about the longitudinal axis of the threaded spindle and in which balls are arranged in a ball row.

The balls are held in ball pockets of a sleeve-shaped ball cage. The ball cage is provided with a plurality of ball pockets that are distributed over its periphery and arranged along the ball channel. In the spindle nut, a helical spring is arranged that is supported on one side on the ball cage and on the other side on the spindle nut. The compressed helical spring provides that the balls or—if the balls are arranged in a ball cage—the ball cage is displaced into a starting position. When there is no load on the ball screw drive, the balls or ball cage can be moved along the ball channel, because the balls merely slide and do not roll on the ball grooves of the threaded spindle and the spindle nut.

A disadvantage in this ball screw drive can be that, in specially constructed designs, the spring end turned toward the spindle nut can become kinked, so that a starting position of the balls or the ball cage cannot be reached.

### SUMMARY

The objective of the present invention is to provide a ball screw drive that operates without problems.

This objective is achieved by the ball screw drive having one or more features of the invention. This ball screw drive is provided with a spindle nut arranged on a threaded spindle and with a helical ball channel defined by ball grooves of the threaded spindle and the spindle nut. In the ball channel there is a ball row formed from balls. A helical spring arranged along the helical ball channel is supported, on one hand, relative to the spindle nut and is provided, on the other hand, for contact on the ball row or on a ball cage holding the balls. The last ball of the ball row or a cage holding the balls can be spring-mounted against the spring end of the helical spring. This helical spring has a number of helical windings that are wound about a spring axis. This spring axis extends along the helical ball channel; thus it follows a helical line.

Therefore, because a rod provided for stabilizing the helical spring engages in the helical spring, an undesired kinking of the helical spring perpendicular to its spring axis is ruled out when the helical spring is loaded and compressed between its support on the spindle nut and the ball row. The helical spring is elastic, while the rod formed, e.g., from steel is comparatively stiff. The rod is inserted into the windings of the helical spring; the windings can contact flush against the rod or can also have play relative to the rod. The rod can have a straight design or it could also have a curved design and be adapted to the curvature of the helical channel if this is desirable so that the rod can engage in the helical spring over more than only a few windings of the helical spring. In this case, the rod can have a curvature that is adapted to the helical ball channel. The rod can be free at its two rod ends, for example, it can be held only by the windings of the helical spring surrounding it.

The rod can also be deflected in a spring elastic manner, that is, have a flexible design, according to a refinement according to the invention. This rod offers the advantage of simplified installation: during installation, the rod can be bent into the curvature of the helical ball channel. When the rod has reached its intended position, it springs back in a spring elastic manner into its straight shape and can be supported with its end turned toward the spindle nut on the contact surface of the spindle nut; alternatively, the sprung-back rod could also engage in a rod mount formed on the spindle nut. The contact and the rod mount could be arranged spatially radially outside of the helical ball channel. This shows the advantage of this refinement according to the invention: During installation, the rod is curved and arranged in the helical ball channel. After installation, the rod is straight and its end turned away from the helical spring can contact the contact surface radially outside of the ball channel or engage in the rod mount.

In particular, the end section of the helical spring turned toward the spindle nut can become kinked in the known arrangement of the helical spring, because the helical spring is led out from the helical ball channel at this end section and can possibly move perpendicular to the spring axis in an undesired way. The rod according to the invention ensures in this end section that the helical spring is stabilized against kinking.

The rod can engage over several windings in the helical spring. This measure can be advantageous in the end section of the helical spring. If the windings of the helical spring contact flush against the rod, the rod is connected captively to the helical spring so that installation is made simpler. In this case, the rod is arranged without play in the helical spring. The rod can alternatively also be arranged with play in the helical spring.

The rod can be supported, on one hand, on the spindle nut and can engage, on the other hand, in the helical spring. With its end turned toward the spindle nut, the rod can contact a contact surface of the spindle nut. To be able to avoid an undesired sliding of the rod from the contact surface, the rod can engage on the spindle nut in a rod mount of the spindle nut.

This rod mount can be formed by a passage hole that penetrates the wall of the spindle nut and through which the rod engages, wherein the rod is supported on both ends of the passage hole with a positive-fit connection on the wall in the directions along the rod axis. In this case, the rod is held captively on the spindle nut. The rod can have a radial flange that is supported on the inner periphery of the spindle nut. A locking ring engaged on the rod can be supported on the outer periphery of the spindle nut. In this arrangement, the rod cannot fall out from the rod opening.

As a captive arrangement, an alternative is provided to form the rod mount by a passage opening that penetrates the wall and is provided at least over a part of its extent with an internal thread in which the rod is screwed with its external thread. In this case, the rod can be formed as a screw, wherein the part engaging in the helical spring can have a smooth cylindrical design.

An alternative invention for meeting the objective forming the basis of the invention can be provided by the following ball screw drive: This ball screw drive is provided with a spindle nut arranged on a threaded spindle and with a helical ball channel defined by ball grooves of the threaded spindle and the spindle nut. In the ball channel there is a ball row formed from balls. A helical spring arranged along the helical ball channel is supported, on one hand, relative to the spindle nut and is provided, on the other hand, for contact on the ball row or a ball cage holding the balls. The last ball of the ball row or a cage holding the balls can be spring mounted against the spring end of the helical spring. This helical spring has a plurality of helical windings that are wound about a spring axis. This spring axis extends along the helical ball channel, thus, follows a helical line. At its end turned toward the spindle nut, the helical spring has a reinforced construction. This reinforcement prevents the undesired kinking of the helical spring described above. The reinforcement can be realized such that the spring is inserted into a cured resin or is bonded with the spindle nut or is molded on with adhesive. The reinforcement extends along the helical spring axis only as far as there is a risk of kinking. The remaining part along the helical spring axis can be placed in the helical ball channel. The solutions shown here could also be combined with each other: for example, bonding and insert molding with adhesive could be combined with each other.

### BRIEF DESCRIPTION OF THE DRAWINGS

The invention will be explained in more detail below with reference to two embodiments shown in a total of seven figures. Shown are:

FIG. 1 a longitudinal section through a locking brake of a motor vehicle with a ball screw drive according to the invention,

FIG. 2 a ball screw drive according to the invention in a perspective diagram, but without the threaded spindle shown,

FIG. 3 a view of the ball screw drive from FIG. 2,

FIG. 4 another ball screw drive according to the invention in a perspective diagram,

FIG. 5 a cross section through the ball screw drive from FIG. 4,

FIG. 6 a cross section through the ball screw drive from FIG. 4, but without a threaded spindle,

FIG. 7 a view of the ball screw drive from FIG. 4, but without a threaded spindle,

FIG. 8 the pin of the ball screw drive according to the invention from FIG. 2 in a view and in a perspective diagram, and

FIG. 9 the pin from FIG. 8 in a curved position, in a view, and in a perspective diagram, and its position in the ball channel.

### DETAILED DESCRIPTION OF THE PREFERRED EMBODIMENTS

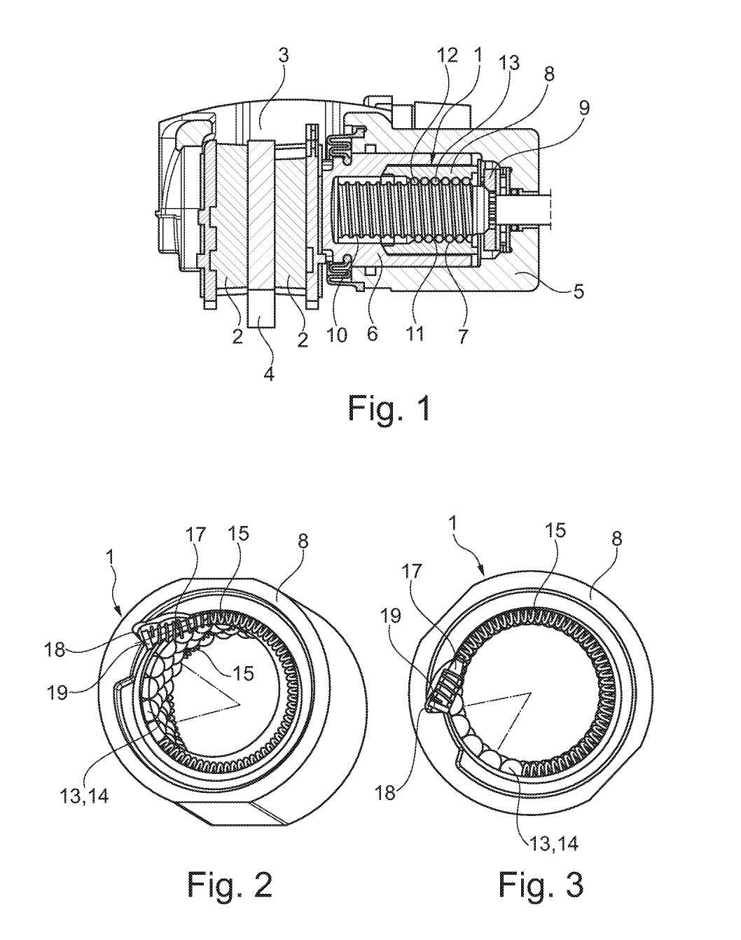

FIG. 1 shows an operating brake of a motor vehicle that is combined with a locking brake according to the invention, wherein this locking brake is provided with a ball screw drive 1 according to the invention. Between two brake shoes 2 of a brake caliper 3, a brake disk 4 is arranged in a known way. A brake piston 6 is arranged in a housing 5. The brake piston 6 can be charged with hydraulic fluid and pressed along its piston axis in the direction toward the brake shoes 2. By actuating the brake piston 6, the brake disk 4 is fixed between the two brake shoes.

In the hollow brake piston 6, the ball screw drive 1 according to the invention is arranged. The ball screw drive 1 has a spindle nut 8 arranged on a threaded spindle 7. For actuating the locking brake, the threaded spindle 7 is set in rotation by means of a not-shown motor. When the threaded spindle 7 rotates, the spindle nut 8 is displaced axially relative to the threaded spindle 7. The spindle nut 8 presses against the brake piston 6 and ultimately presses this against the adjacent brake shoe 4. The threaded spindle 7 is supported axially by means of an axial bearing 9 on the housing 5. The axial compressive forces between the brake piston 6 and the spindle nut 8 are transmitted via the threaded spindle 7 and the axial bearing 9 into the housing 5. The threaded spindle 7 is provided with a ball groove 10 wound helically about the spindle axis. The spindle nut 8 is provided on its inner periphery with a ball groove 11 wound helically about the nut axis. The ball grooves 10 and 11 define, in common, a helical ball channel 12 in which balls 13 are arranged. The balls 13 can roll on the ball grooves 10, 11.

FIG. 2 shows the ball screw drive 1 according to the invention in a perspective diagram, but without the threaded spindle. The balls 13 arranged along the helical ball channel 12 in a ball row 14 can be clearly seen. Along the helical ball channel 12 there are two helical springs 15 that each have a plurality of windings 16. These windings 16 wind about a spring axis that is arranged along the helical ball channel 12. One helical spring 15 attaches to one end of the ball row 14 and the other helical spring 15 attaches to the other end of the ball row 14. Both helical springs 15 are supported on one side relative to the spindle nut 8 and on the other side on the ball row 14.

The following constructions for one helical spring 15 with respect to its arrangement and securing against lateral kinking also apply to the other helical spring 15.

FIGS. 2 and 3 clearly show that the end of the helical spring turned away from the ball row 14 is led out from the helical ball channel 12. A rod 17 provided for stabilizing the helical spring 15 engages in the helical spring 15. The rod 17 engages in the helical spring 15 over several windings; in the embodiment, the rod 17 extends over the section of the helical spring 15 that is formed outside of the ball channel 12 formed jointly by the ball grooves 10, 11 of the spindle nut 8 and the threaded spindle 7; in particular, this section is secured by the inserted rod 17 against lateral kinking of the helical spring 15 perpendicular to the spring axis.

The rod 17 is arranged with radial play or no play in the helical spring 15. The windings 16 can contact flush against the rod 17 and enable a captive connection between the rod 17 and the helical spring 15; however, it is sufficient if play is formed between the rod 17 and the helical spring 15; kinking of the helical spring 15 can also be ruled out if there is play.

The rod 17 is supported on the spindle nut 8. With its rod end turned toward the spindle nut 8 and formed as a radial flange 19, the rod 17 contacts a contact surface 18 of the spindle nut 8. The spring end of the helical spring 15 contacts the radial flange 19. To avoid undesired sliding of the rod 17 from the contact surface 18, the rod 17 can be held captively on the spindle nut 8 in a rod mount of the spindle nut, as is explained in detail in another embodiment below.

It is not absolutely necessary to provide a helical spring on both ends of the ball row. The compressed helical spring 15 ensures that the balls 13 are displaced into a starting position. For an unloaded ball screw drive 1, the balls 13 can be shifted along the ball channel 12, because the balls 13 merely slip and do not roll on the ball grooves 10, 11 of the threaded spindle 7 and the spindle nut 8. For returning the ball row 14 into a starting position, it can be sufficient to provide only one helical spring 15.

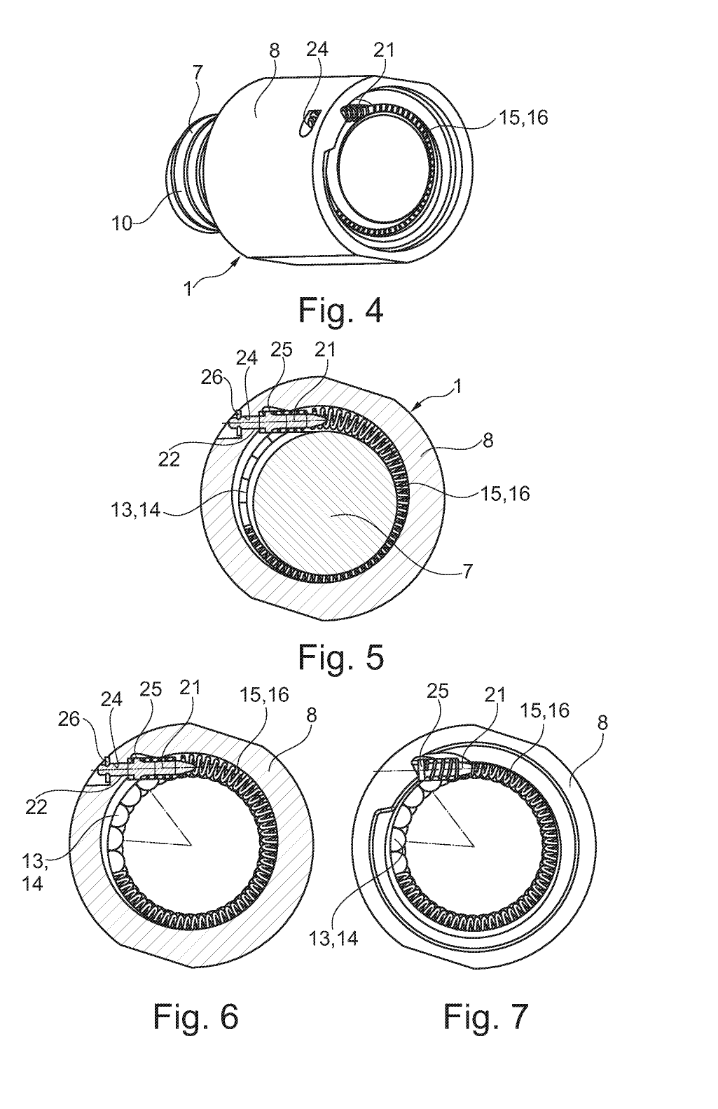

The ball screw drive 1 according to the invention shown in FIGS. 4 to 8 differs from the embodiment described above merely in that a modified rod 21 and a rod mount 22 adapted to the rod and formed on the spindle nut 8 are provided.

The rod mount 22 is formed by a passage hole 24 that penetrates the wall 23 of the spindle nut 8 and through which the rod 21 engages, wherein the rod 21 is supported on both ends of the passage hole 24 with a positive-fit connection on the wall 23 in the directions along a rod axis of the rod 21. The rod 21 has a radial flange 25 that is supported on the inner periphery of the spindle nut 8. A locking ring 26 engaged on the rod 21 is supported on the outer periphery of the spindle nut 8, in the embodiment on a shoulder surface of the spindle nut 8 formed perpendicular to the rod axis. In this arrangement, the rod 21 cannot fall out from the rod opening and is held in its intended position.

An alternative captive arrangement can be provided in that, instead of the radial flange 25 and the locking ring, an external thread is formed on the rod 21 that engages in an internal thread of the passage hole 24. In this case, the rod 21 can have a screw head that is accessible from radially outside of the spindle nut 8 and is screwed onto the shoulder surface of the spindle nut 8.

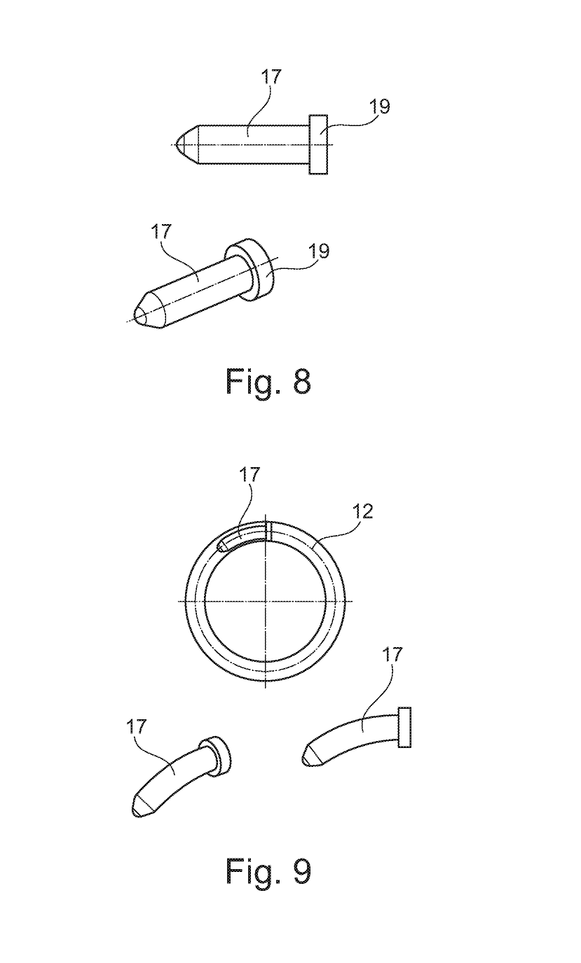

FIGS. 8 and 9 show the rod 17 that is produced from a flexible material, so that it can be deflected from its straight shape (FIG. 8) in a spring elastic manner, in order to be adapted to the curvature of the helical ball channel 12. The flexibility of the rod 17 makes its installation in the ball screw drive possible: first the rod is inserted in a curved arrangement into the helical ball channel; when it has reached its predetermined position, the rod 17 springs back into its straight shape in a spring elastic manner, and comes into contact, with its flange 19, on the contact surface 18 of the spindle nut 8, as shown in FIG. 2.

In all of the embodiments according to the invention, the helical springs provide for a trouble-free starting position of the balls when the ball screw drive is not loaded, which will be explained in more detail below with reference to the first embodiment.

When the operating brake is actuated, the hydraulically loaded brake piston 6 presses against the brake shoes 2, wherein the brake piston 6 is displaced axially relative to the spindle nut 8. Now if the driver actuates the locking brake, the threaded spindle 7 is set in rotation, wherein the spindle nut 8 is displaced axially in the direction toward the brake piston 6. During this phase, the spindle nut 8 is not loaded and the balls 13 slip along the ball channel 12. A relative rotation of the ball row 14 relative to the spindle nut 8 stops first. Finally, the spindle nut 8 contacts, on its end face, on the brake piston 6 and is loaded axially. Under this axial loading, the balls 13 are loaded and these now roll on the ball grooves 10, 11. The balls 13 of the ball row 14 now roll on the ball groove 11 and are displaced relative to the spindle nut 8, wherein the helical spring 15 working as an adjusting spring is compressed. Finally, the adjustment path of the spindle nut 8 is ended and the locking brake is activated.

If the locking brake is released again, the spindle nut 8 moves back. When the spindle nut 8 is not loaded, the ball row 12 is moved back into its starting position when the load is removed from the compressed helical spring 15.

The situation can occur that the operating brake is still activated with a very high braking effect when the locking brake is actuated. Then the axial compressive force present due to the actuation of the locking brake is increased between the brake piston 6 and the spindle nut 8, as soon as the hydraulic pressure is removed from the operating brake. Then, under the elastic relaxing of the previously clamped parts—for example, the brake caliper can be expanded elastically—the brake piston 6 presses against the spindle nut 8 with greater force.

In the previously described situation, the balls 13 are in rolling contact with the ball grooves 10, 11 over a longer rolling path during the release of the locking brake. Initially, the helical spring 15 operating as an adjusting spring is relaxed. However, because the ball row 14 is moved farther due to an increased rotational angle under loading, the ball row 14 lifts from the helical spring 15. The intended starting position of the ball row 14 is thus exceeded. The ball row 14 now presses against the other helical spring that acts as a preliminary compression spring. Under compression of the preliminary compression spring, the ball row 14 is moved relative to the spindle nut 8 until the balls 13 are not loaded. Now the ball row 14 is moved under the pressure of the preliminary compression spring for sliding balls 13 in the direction of its intended starting position until the preliminary compression spring is not loaded or a balance of forces is established between the two helical springs 15. The ball row is now in its intended starting position.

The preliminary compression spring is not absolutely necessary. Embodiments according to the invention are also possible in which merely the adjusting spring is provided.

In all of the embodiments, the helical spring must be secured against kinking perpendicular to the spring axis by means of the inserted rod.

### LIST OF ITEM NUMBERS

1 Ball screw drive
2 Brake shoe
3 Brake caliper
4 Brake disk
5 Housing
6 Brake piston
7 Threaded spindle
8 Spindle nut
9 Axial bearing
10 Ball groove
11 Ball groove
12 Ball channel
13 Ball
14 Ball row
15 Helical spring
16 Winding
17 Rod
18 Contact surface
19 Radial flange
20 - - -
21 Rod
22 Rod mount
23 Wall
24 Passage hole
25 Radial flange
26 Locking ring

1. A ball screw drive, comprising a spindle nut arranged on a threaded spindle having a helical-shaped ball channel that is limited by ball grooves of the threaded spindle and the spindle nut and in which a ball row formed from balls is arranged, and a helical spring arranged along the helical-shaped ball channel is supported relative to the spindle nut and is provided for contact on the ball row or on a ball cage holding the balls, and a rod for stabilizing the helical spring engages in the helical spring.

2. The ball screw drive according to claim 1, wherein the rod provided for stabilizing the helical spring is supported on the spindle nut and engages in the helical spring.

3. The ball screw drive according to claim 1, wherein the rod engages in the helical spring over several windings.

4. The ball screw drive according to claim 1, wherein the rod is provided as an anti-kink device against kinking of the helical spring perpendicular to a spring axis of the helical spring.

5. The ball screw drive according to claim 1, wherein the rod is arranged with radial play or no play in the helical spring.

6. The ball screw drive according to claim 1, wherein the rod is held captively on the spindle nut.

7. The ball screw drive according to claim 1, wherein the rod engages in a rod mount of the spindle nut.

8. The ball screw drive according to claim 7, wherein the rod mount is formed by a passage hole that penetrates a wall of the spindle nut and through which the rod engages, and the rod is supported with a positive-fit connection at both ends of the passage hole on the wall in directions along a rod axis.

9. The ball screw drive according to claim 7, wherein the rod mount is formed by a passage opening that penetrates a wall of the spindle nut and is provided with an internal thread in which the rod is screwed with an external thread on the rod.

10. The ball screw drive according to claim 1, wherein the rod has a curvature that is adapted to the helical ball channel.

11. The ball screw drive according to claim 10, wherein the rod is deflectable in a spring-elastic way from a straight shape into a curved shape with the curvature.

12. A locking brake of a motor vehicle, with a brake piston that is arranged displaceably along a piston axis for achieving a braking effect and with a ball screw drive according to claim 1 for actuating the brake piston.
